(19) United States
(12) Patent Application Publication
(10) Pub. No.: US 2005/0166215 A1
(43) Pub. Date: Jul. 28, 2005

(54) Common user interface for interacting with various interfaces

(75) Inventors: Lane Thomas Holloway, Pflugerville, TX (US); Walid Kobrosly, Round Rock, TX (US); Nadeem Malik, Austin, TX (US); Avijit Saha, Somers, NY (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/765,778

(22) Filed: Jan. 27, 2004

(51) Int. Cl. G06F 9/44; G06F 15/16

(52) U.S. Cl. 719/329; 709/203

(57) ABSTRACT

Methods, systems, and media are disclosed for interaction between a client device having a common interface and a server device having an interface. One example embodiment includes the client device receiving user interface descriptions, in the form of xml files, from the server device, wherein the user interface descriptions comprise commands and options for possible actions on the interface of the server device. Further, the example embodiment includes mapping of the commands and options to pre-configured inputs on the common interface, thereby producing mapped inputs. Further still, the example embodiment includes transmitting a selected one of the mapped inputs from the client device to the server device for the server device to execute the selected one of the mapped inputs, that is, the underlying command or option associated with the mapped input.

### FIELD OF INVENTION

The invention generally relates to user interacting with the many different user interfaces found on devices. More particularly, the invention relates to methods, systems, and media for interacting between a client device having a common interface and server devices having varied interfaces.

### BACKGROUND

User interfaces (“UIs”) are the junction between a user and a computer program, and constitute one of the most important parts of any program because UIs determine how easily a user may utilize the program. For instance, a powerful program with a poorly designed UI has little value because users may not understand how to maximally utilize the program. As such, a primary focus of UI design rests in what is termed “user-friendliness.” That is, a focus on how easily a user may fully use the program.

Typically, UIs are a set of commands or menus through which a user communicates with a program. Keeping with user-friendliness, UIs, today, generally incorporate graphics, and are collectively referred to as graphical user interfaces (“GUIs”). For example, GUIs use windows, icons, pop-up menus, pointers, and the like to free the user from learning complex command language in order to communicate, i.e., operate, the underlying program.

Despite advances in user-friendliness, a problem remains: users still must learn and understand the many different types of UIs that exist in order to properly communicate with a program, such as a program controlling a vending machine or an automated teller machine (“ATM”). That is, not all vending machines have the same UIs, and vending machines have UIs that differ from UIs for ATMs. Although UIs for vending machines and ATMs are generally very simplistic, and, therefore, mastering these different types of UIs seems trivial, the first time user must still take the time to learn and understand these UIs. Even if the learning curve is generally very low for UIs associated with vending machines and ATMs, even these UIs are problematic for a user when, for example, introducing a language barrier to the UI. Stated another way, that is, by example, an American user of a UI for an ATM in China would likely be difficult if the American does not know the Chinese language. Thus, it is apparent how even some of the simplest UIs among the many different types of UIs may be problematic for users.

The core of the problem at issue is that no one standard user interface exists for all devices in the universe. Thus, users must now take the time to learn the many different UIs in order to use the underlying programs because no movement will likely germinate to foment a standard user interface: not all businesses want to market their goods and services in the same manner, and viewing UIs as a marketing tool, then different UIs will always exist. As a result, if let unsolved, then the problem of users having to master the many types of different interfaces should only increase as society continues towards a more pervasive computing environment.

A need, therefore, exists, for methods, systems, and media for users to interact with the many different types of interfaces without the user having to learn the specific operability requirements for each of the many different types of interfaces.

### SUMMARY OF THE INVENTION

Embodiments of the invention generally provide methods, systems, and media for interacting between a client device having a common interface and a server device having an interface. In one embodiment, the method generally includes receiving, by the client device, of user interface descriptions from the server device, wherein the user interface descriptions comprise commands and options. Further, the method includes mapping of the commands and options to inputs on the common interface, thereby producing mapped inputs. Further still, the method includes transmitting a selected one of the mapped inputs from the client device to the server device for execution by the server device. In a further embodiment, the method includes executing the selected one of the mapped inputs received by the server device.

In another embodiment, the invention provides a system for interaction between a client device having a common interface and a server device having an interface. The system includes a receiver on the client device for receiving user interface descriptions from the server device, wherein the user interface descriptions comprise commands and options. Further, the system further includes a mapping module associated with the client device for mapping of the commands and the options to inputs on the common interface, thereby producing mapped inputs. Further still, the system includes a client transmitter for transmitting a selected one of the mapped inputs from the client device to the server device. In a further embodiment, the system includes an executor module for executing the selected one of the mapped inputs received by the server device.

In yet another embodiment, the invention provides a machine-accessible medium containing instructions, which when executed by a machine, cause the machine to perform operations for interacting between a client device having a common interface and a server device having an interface. The instructions generally include operations for receiving, by the client device, of user interface descriptions from the server device, wherein the user interface descriptions comprise commands and options. Further, the instructions include operations for mapping of the commands to inputs on the common interface, thereby producing mapped inputs. Further still, the instructions include operations for transmitting a selected one of the mapped inputs from the client device to the server device for execution by the server device. In a further embodiment, the instructions include operations for executing the selected one of the mapped inputs received by the server device.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a system for interacting between a client device having a common interface and a server device having an interface in accordance with the disclosed invention.

FIG. 2 depicts an example embodiment of a system for interacting between a client device having a common interface and a server device having an interface in accordance with the disclosed invention.

FIG. 3 depicts an example embodiment of a method for interacting between a client device having a common interface and a server device having an interface in accordance with the disclosed invention.

### DETAILED DESCRIPTION OF EXAMPLE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for interacting between a client device having a common interface and a server having an interface are contemplated. Embodiments include a user having configured a common interface in a manner of user choice. That is, configuration of the common interface may include, for example, a user configuring, through logic associated with the client device, of one or more pages displayed on a screen of a client device, such as a personal digital assistant (“PDA”) or a cell phone. The one or more pages are for configured inputs that form the common interface that the user uses for interacting with server devices, such as vending machines, ATMs, computers, phones, and televisions, all of which have their own and different interface. The inputs, themselves, on the configured, common interface may take the form, for example, of simple commands buttons, such as “buy,” “dispense,” “translate,” and “send,” and/or the form of list boxes, radio buttons, check boxes, and text entry boxes for user-selectable options. Further, based on logic associated with the client device, a user may select such inputs, for example, through use of a stylus, keypad, arrow keys or by the user touching the screen of the client device.

After a general configuration of the common interface to form the common interface on the client device, the user is ready to interact in an already known manner with a server device quite possibly having an interface unknown to the user. To interact, the server device and the client device communicate through any of a variety of communication means available between the server device and the client device. That is, depending on enabling logic and equipment associated with both the client device and the server device, communication may occur, for example, through a wireless network, through a wired network, through Bluetooth™, or through infrared data association (“IRDA”). In short, proximity between the client device and the server device is critical only if the chosen communication means requires proximity for receiving and transmitting signal transference.

With communication existing between the client device and the server device, the client device receives user interface descriptions from the server device. The user interface descriptions contain commands capable of execution by a user interacting with the server device's interface. That is, if the user were to walk up and use the interface of the server device, then depressing a button, for example, on the interface would result in execution of the command, such as “dispensing” a chosen candy bar from a vending machine, associated with the depressed button. The user interface descriptions also contain options, such as the types of food available for selection in a vending machine.

With the client device having received the user interface descriptions, logic, enabled by software and or hardware, maps the commands and options from the user interface descriptions to the common interface of the client device. The mapping results in assigning the commands and options of the server device to inputs of the client device, wherein the inputs are user-configured. As a result, rather than using the interface located on the server device, the user now may use the common interface of the client's device to select one or more of the mapped inputs, which are transmitted back to the server device for execution. In short, to use the candy bar purchase analogy again, the user selects one or more inputs on the client device, to select the type, i.e., option, and command, i.e., purchase, of a desired candy bar in the vending machine, the server device.

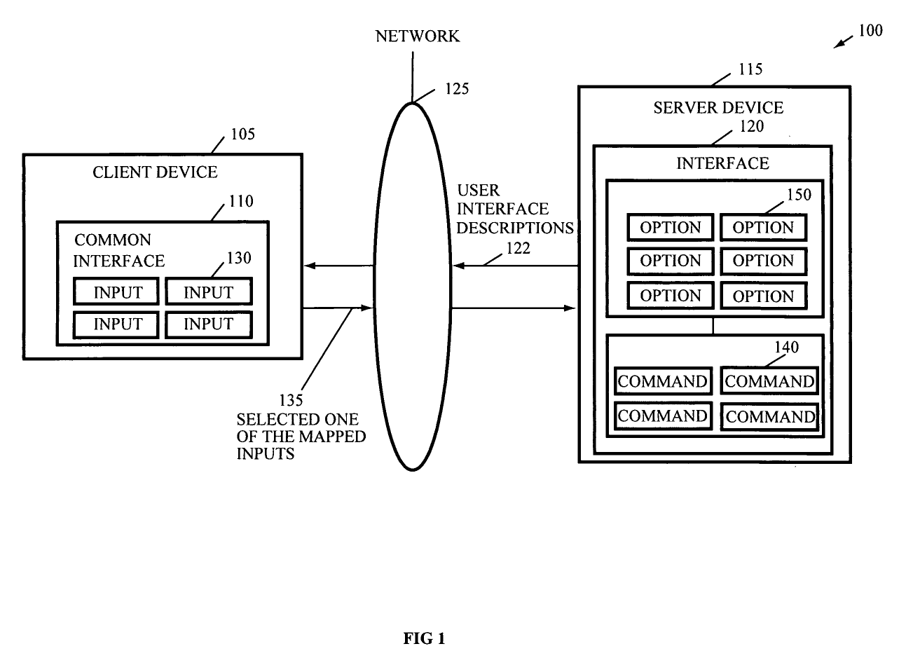

Turning now to the drawings, FIG. 1 depicts an embodiment of a system 100 for interacting of a client device 105 having a common interface 110 with a server device 115 having an interface 120. Before commencing interaction, however, a user generally configures the common interface 110 of the client device 105, such as a cell phone or a PDA, for interaction with various interfaces of server devices 115, such as vending machines, ATMs, telephones, televisions, and computers. Configuration of the common interface 110 occurs through logic, enabled through software and/or hardware associated with the client device 105. The user configures the common interface 110 by configuring inputs 130 on the client device 105. The inputs 130 take a form and definition as defined by the user and permitted by the associated logic. That is, the inputs 130 may take the form of drop-down boxes, check boxes, radio buttons, text entry boxes, scroll-through boxes, or may simple be buttons, all of which may appear on a screen on the client device 105. For example, the user may configure inputs 130 for “buying” or “dispensing” as buttons, that might be used for buying or dispensing of a candy bar from a vending machine, or may configure a scrollable box for adjusting of an input of “quantity” for use in adjusting the tint on a TV screen or the number of candy bars to dispense from a vending machine. Further, logic associated with the client device 105 determines how selection of the inputs 130 occurs. That is, the logic may permit touch-screen selection of an input 130, or stylus selection of an input 130, or even keystroke selection of an input 130. After general configuration of the common interface 110, the user may commence interaction with the world of varied interfaces through the common interface 110.

To initiate interaction, the system 100 depicts the communication means between the client device 105 and the server device 115 being through a wireless network 125. However, other communication means are possible without departing from the scope of the invention. For example, the communication means may occur through Bluetooth™, IRDA, and a wired computer network provided the client device and server device are properly enabled with the necessary equipment and logic known to one of ordinary skill in the art. Initiation of the communication between the client device 105 and the server device 115 may occur by various means, such as user selecting one of the user-configured inputs 130 for establishing communication. Other means, however, are possible for communication connectivity, and include, for example, the user depressing a designated button on the client device 105 for requesting and establishing communication connectivity between the client device 105 and the server device 115, or the server device 115 sensing close proximity of a client device 105 and prompting the client device 105 whether the user of the client device 105 desires connectivity to the server device 115.

After establishing connectivity, the client device 105 receives user interface descriptions 122 from the server device 115 through the network 125 depicted in FIG. 1. Receipt of the user interface descriptions 122 occurs through logic, enabled by software and/or hardware, located on both the client device 105 for receiving and the server device 115 for sending of the user interface descriptions 122. Notably, the logic on the server device 115 for sending the user interface descriptions 122 to the client device 105 may be integral to the server device 115, or the functionality may be reduced to and encompassed within an add-on device in communication with the server device 115, wherein the add-on device operates as the server device 115 by connecting to a vending machine or other device through, for example, a USB port on the vending machine or other device. In such an example embodiment, the add-on device is understood to constitute the server device 115 for purposes of the invention discussed herein because all of the interaction discussed herein actually occurs between the client device 105 and the add-on device.

Returning to the user interface descriptions 122 received by the client device 105, the user interface descriptions 122 contain commands 140 and options 150 associated with the interface 120 of the server device 115. The user interface descriptions 122 that the client device 105 receives are in xml files. The xml files consist of a schema file and a file containing the commands 140 and options 150, whereby the client device uses the schema to interpret the xml file containing the commands 140 and options 150. By example, the commands 140 for interacting with a server device 115 such as a vending machine may be “buy” and “dispense” or a command 140 for a server device 115 such as phone may be “dial.” Options 150, for example, for the server device 115 for the vending machine may be, for example, “type” or “quantity” of food, or, for the phone, may be “number,” as in a phone number. The possible commands 140 and options 150 are essentially limitless because the inputs 130 on the client device 110 are only limited by the imagination of the user configuring the client device 105, and the configuration may be newly configured over and over again or “on the fly” while a user is interacting with a particular server device 115 having an interface 120.

After receiving the user interface descriptions 122, the client device 105, through logic enabled by software and/or hardware associated with the client device 105, maps the commands 140 and options 150 from the xml files to inputs 130 on the common interface 110. For commands 140 and options 150 unable to be mapped to pre-configured inputs 130 on the common interface 110, the client device, through enabling software and/or hardware logic, prompts the user for configuring of additional inputs 130 to permit mapping of the unmapped commands 140 and options 150 to produce newly configured inputs 130. That is, the prompting permits configuration of additional inputs 130 to ensure that all commands 140 and options 150 received from the server device 115 for its interface 120 are mapped to at least one of the inputs 130 on the common interface 110. As a result of the mapping, the inputs 130 are now termed mapped inputs 130.

The system 100 further includes transmission of a user-selected, mapped input 135 over the wireless network 125 to the server device 115. The transmitted and received mapped input 135 selected by the user is an xml file that contains the commands 140 and options 150 of the server device 115 that underlies the selected, mapped input 130. As a result, the server device 115 reads the xml file associated with the selected, mapped input 130, and performs the underlying command 140 and option 150. For example, suppose the selected, mapped input 130 is the user's selected input 130 for “purchasing” of a Hershey™ candy bar from a vending machine. Because the xml file for the commands 140 and options 150 already mapped the server device's 115 command of “purchase” and option of “Hershey™ candy bar” to, for example, the user's configured inputs 130 of a “buy” button and “item type” scrollable box, respectively, then when the user selects “buy” and “Hershey™ candy bar,” the server device 115 reads the xml file transmitted with these user-selected inputs 130, and performs the underlying command of “buy” and option of “Hershey™ candy bar” in order to execute, that is, dispense, the Hershey™ candy bar from the vending machine.

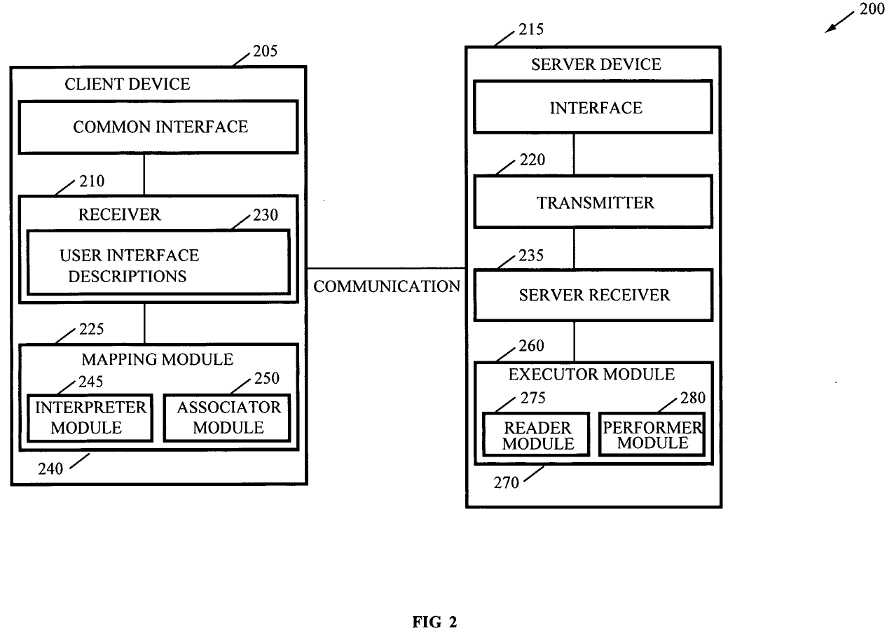

Turning now to FIG. 2, an example embodiment of a system 200 for interaction between a client device 205 having a common interface 210 and a server device 215 having an interface 220 is depicted. In the system 200, a receiver 225 on the client device 205 receives user interface descriptions from a transmitter 235, for example, located on the server device 215. The receiver 225 may receive the user interface descriptions 230 from the transmitter 235 through various communication means, such as, for example, a wireless network, a wired network, Bluetooth™, or IRDA. Choice of the communication means for permitting the receiver 225 to receive user interface descriptions 230 from a transmitter 235 is a decision likely made by the manufacturer of components used in such a system 200, but from an enablement perspective, all that is required is enabling logic and equipment on both the client device's 205 receiver 225 and the server device's 215 transmitter 235, already known to those of ordinary skill in the art, to permit a particular communication means for allowing connectivity and communication to occur between the receiver 225 and transmitter 235.

In the above-discussion of the system 100 depicted by FIG. 1, the user interface descriptions 230 of the system 200 in FIG. 2 are again discussed for further illustration and enabling purposes. Before turning to more discussion of the user interface descriptions 230, however, a configurator module 207, enabled by logic in software and/or hardware, permits the user to configure the inputs, in a manner of the user's choosing, on the common interface 210 of the client device 205. That is, the configurator module 207 enables the user to configure inputs in the form of text boxes, check boxes, radio buttons, drop-down lists, and other form desired by the user. The configured inputs are then ready for the user interface descriptions 230 to be received by the receiver 235, which are passed, through logic, enabled by software and/or hardware located on the client device 205, such as, for example, a PDA, mobile phone, or other portable, computing device having a user-configurable interface into a common interface 210, to a mapping module 240 associated with the client device 205. The mapping module 240, enabled by logic in software and/or hardware associated with the client device 205, is the workhorse of the system 200 for the mapping of the user interface descriptions to inputs either already configured or to be configured by the user on the common interface 210 of the client device 205. The mapping module 240 includes an interpreter module 245 for interpreting the received user interface descriptions 230, which are received in an xml format in the form of a xml schema file and an xml file containing the various commands and options that would be available to a user through use of the interface 220 located on the server device 215. A further component of the mapping module 240, namely an associator module 250, then associates the received commands and options to a pre-configuration of the inputs on the common interface 210. The associator module 250 further includes logic for prompting the client device 205 to configure inputs for commands and inputs that are not mappable to pre-configuration inputs of the common interface 210, and, thereby, permits the user of the common interface 210 to configure additional inputs on the fly, that is, during an interaction with an interface 220, to ensure that all of the received commands and inputs from the server device 215 are mapped to inputs of the common interface 210 on the client device 205. In the end, the mapping module 240 produces mapped inputs out of the user-configured inputs on the common interface 210, wherein the mapped inputs are specific to the interface 220 of the server device 215 with which the common interface 210 of the client device 205 is currently interacting.

The system 200 further includes a client transmitter 255, enabled by logic in software and/or hardware associated with the client device 205, for transmitting a user-selected, mapped input from the client device 205 to a server receiver 260 on the server device 215. As previously discussed, the communication means for effectuating the transmitting and receiving may occur, for example, through a wireless network, a wired network, Bluetooth™, or IRDA. The server receiver 260, enabled by logic in software and/or hardware associated with the server device 215, receives the transmitted, user-selected, mapped input in an xml format. The system 200 further includes an executor module 270, enabled by logic in software and/or hardware associated with the server device 215, containing a reader module 275 for reading the xml file associated with received, user-selected, mapped input. That is, the reader module 275 reads the xml file to identify the particular command or option mapped to the user-selected input, and a performer module 280, performs the mapped command or option.

The functionality for the invention on the server device 215 side of the system 200 may be integral to the server device 215, that is integrally interwoven into the computer system controlling the server-side device, such as a vending machine, for example. Another optional embodiment is for reduction of the functionality of the invention disclosed herein to an add-on device that removably connects, through, for example, a USB adapter, to the server-side device, such as a vending machine. In such an optional embodiment, the client device 205 having the common interface 210 communicates directly with the add-on device that is in communication with the particular server-side device to which the add-on device has been connected. As a result, the add-on device is fully enabled, as above-discussed, to operate as the server device 215 for purposes of the invention disclosed herein. In addition, the add-on device should be construed as controlling and performing all of the functionality disclosed herein wherever discussion in terms of the system 200 for server device 215 occurs.

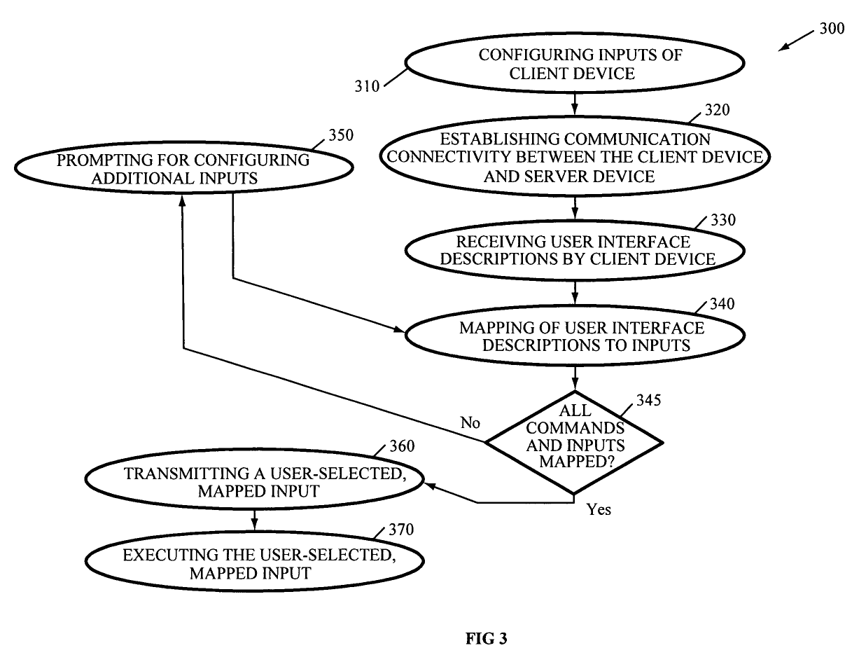

Turning now to FIG. 3, another aspect of the invention is disclosed. In particular, an embodiment of a flowchart 300 for interacting between a client device having a common interface and a server device having an interface is disclosed. Flowchart 300 is for a system, such as systems 100 and 200, as shown in FIG. 1 and FIG. 2.

Flowchart 300 begins by configuring 310 inputs of a common interface displayed on a screen of a client device, such as PDA or mobile phone, wherein the common interface is the interface for the user to interact with the world of differing interfaces, and, thereby, remove the time and difficulty of having to master these differing interfaces for use of the underlying computer program associated with these differing interfaces. Through logic associated with the client device, the user configures 310 what are termed inputs on the common interface. The inputs may take the form of drop-down boxes, check boxes, radio buttons, text entry boxes, scroll-through boxes, or may simple be buttons, all of which may appear on a screen on the client device 105. For example, the user may configure inputs for “buying” or “dispensing” as buttons, that might be used for buying or dispensing of a candy bar from a vending machine, or may configure a scrollable box for adjusting of an input of “quantity” for use in adjusting the volume on a DVD device or the number of candy bars to dispense from a vending machine. Further, logic associated with the client device determines how selection of the inputs occurs. That is, the logic may permit touch-screen selection of an input, or stylus selection of an input, or even keystroke selection of an input. After general configuring 310 of the common interface, the user may interact with the world of varied interfaces through the common interface having configured inputs.

Moving down the flowchart 300, the flowchart 300 continues by establishing 320 communication connectivity between the client device and a particular server device having an interface with which the client device's common interface will interact. Establishing 320 communication may be occur, for example, by the user depressing a configured input on the common interface, that is, sending of a request by the user to establish communication availability with a particular server device. As further examples, establishing 320 communication may occur by the user depressing a dedicated button on the client device for establishing communication or by either the client device or a particular server device prompting the other for establishing a connection when the devices are within a pre-defined proximity of each other. Regardless of how communication is established, the communication may occur through various communication means, such as, for example, a wireless network, a wired network, Bluetooth™, or IRDA. The communication means is a decision likely made by the manufacturer of components, but from an enablement perspective, all that is required is enabling logic and equipment on both the client device and the server device, already known to those of ordinary skill in the art, to permit a particular communication means for connectivity and communication to occur between the client device's common interface and the server device.

The flowchart 300 continues by the client device receiving 330 user interface descriptions from the server device, such as a vending machine, ATM, phone, VCR, or television. The user interface descriptions are xml files that contain a schema and the commands and options associated with the interface of the server device. After receiving 330 the user description files, that is, the xml files, from the server device, the flowchart 300 further continues by mapping 340 of the user interface descriptions to inputs on the common interface. For mapping 340 of the user interface descriptions, logic associated with the client device reads the xml schema file and associates the commands and options of the server device's interface with inputs of the common interface. Continuing further down the flowchart 300, a decision block 345 depicts whether all of the commands and options of the server device's interface have been mapped to configured inputs on the common interface. If not, the client device contains further logic for prompting 350 the client device for configuring additional inputs for the mapping 340 of commands and options in the received user interface descriptions that were unmappable to the existing configured inputs of the common interface on the client device. This prompting 350 ensures that all of the commands and options available at the interface are also available for selection, and ultimate execution, through user of the common interface on the client device. As a result of the mapping 340, the configured inputs are now transformed into mapped inputs for the server device with which the common interface of the client device is currently interacting.

Moving further down the flowchart 300, the flowchart 300 continues by transmitting 360 a user-selected, mapped input from the common interface of the client device to the server device through use of the same communication means used for receiving 330 the user interface descriptions. As with the configuring 310, selection of the mapped input is made possible by logic associated with the client device for enabling selection. That is, the logic may permit the touching of a stylus or a finger to select the particular mapped input, or the logic may permit a keystroke to select the particular mapped input. Regardless of how the mapped input is user-selected, transmitting 360 of the user-selected, mapped input to the server device is via an xml file that is received by the server device. The flowchart 300 then culminates in executing 370 the user-selected, mapped input by reading the xml file associated with received, user-selected, mapped input and a performing the underlying command or option associated with the user-selected mapped input.

Another embodiment of the invention is implemented as a program product for use with a computer system such as, for example, the system 100 and system 200 shown in FIG. 1 and FIG. 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

1. A method for a client device having a common interface to interact with a server device having an interface, the method comprising:
receiving, by the client device, of user interface descriptions from the server device, wherein the user interface descriptions comprise commands and options;
mapping of the commands and the options to inputs on the common interface, thereby producing mapped inputs; and
transmitting a selected one of the mapped inputs from the client device to the server device for execution by the server device.

2. The method of claim 1, further comprising executing the selected one of the mapped inputs received by the server device.

3. The method of claim 2, wherein the executing comprises reading xml associated with the selected one of the mapped inputs transmitted to the server device, and performing the selected one of the mapped inputs.

4. The method of claim 1, further comprising prompting the client device for the mapping.

5. The method of claim 1, further comprising configuring, by the user, of the inputs on the common interface of the client device.

6. The method of claim 1, further comprising prompting the client device for configuring one or more of the inputs on the common interface.

7. The method of claim 1, wherein the receiving of the user interface descriptions comprises receiving xml files.

8. The method of claim 1, wherein the receiving and the transmitting comprises via wireless communication between the client device and the server device.

9. The method of claim 1, wherein the mapping comprises interpreting the user interface descriptions and associating each of the commands and the options with the inputs.

10. A system for a client device having a common interface to interact with a server device having an interface, the system comprising:
a receiver on the client device for receiving user interface descriptions from the server device, wherein the user interface descriptions comprise commands and options;
a mapping module associated with the client device for mapping of the commands and the options to inputs on the common interface, thereby producing mapped inputs;
a client transmitter for transmitting a selected one of the mapped inputs from the client device to the server device for execution by the server.

11. The system of claim 10, further comprising an executor module for executing the selected one of the mapped inputs received by a server receiver on the server device.

12. The system of claim 11, wherein the executor module comprises a reader module for reading xml associated with the selected one of the mapped inputs received by the server device, and a performer module for performing the selected one of the mapped inputs.

13. The system of claim 11, wherein the server device comprises a functionality reduced to an add-on device.

14. The system of claim 10, further comprising a configurator module for configuring, by the user, of the inputs on the common interface of the client device.

15. The system of claim 10, wherein the client device comprises a portable device.

16. The system of claim 10, wherein the client device comprises a PDA.

17. The system of claim 10, wherein the server device comprises a vending machine.

18. The system of claim 10, wherein the mapping module comprises an interpreter module for interpreting the user interface descriptions and an associator module for associating each of the commands and the options with the inputs.

19. A machine-accessible medium containing instructions, which when executed by a machine, cause the machine to perform operations for a client device having a common interface to interact with a server device having an interface, comprising:
receiving, by the client device, of user interface descriptions from the server device, wherein the user interface descriptions comprise commands and options;
mapping of the commands and the options to inputs on the common interface, thereby producing mapped inputs; and
transmitting a selected one of the mapped inputs from the client device to the server device for execution by the server device.

20. The machine-accessible medium of claim 19, wherein the instructions further comprise operations for executing the selected one of the mapped inputs received by the server device.

21. The machine-accessible medium of claim 20, wherein the instructions for executing comprise instructions for reading xml associated with the selected one of the mapped inputs transmitted to the server device, and instructions for performing the selected one of the mapped inputs.

22. The machine-accessible medium of claim 19, wherein the instructions further comprise operations for prompting the client device for the mapping.

23. The machine-accessible medium of claim 19, wherein the instructions further comprise operations for configuring, by the user, of the inputs on the common interface of the client device.

24. The machine-accessible medium of claim 19, wherein the instructions further comprise operations for prompting the client device for configuring one or more of the inputs on the common interface.

25. The machine-accessible medium of claim 19, wherein the instructions for receiving and the instructions for transmitting comprise via wireless communication between the client device and the server device.

26. The machine-accessible medium of claim 19, wherein the instructions for mapping comprise instructions for interpreting the user interface descriptions and instructions for associating each of the commands and the options with the inputs.

27. A method for a server device having an interface to interact with a client device having a common interface, the method comprising:
receiving, by the server device, of a selected input on the common interface of the client device, wherein the selected input comprises an xml file having user interface descriptions mapped to selected input; and
executing the selected input based on the xml file received by the server device.
